(19) United States
(12) Patent Application Publication
(10) Pub. No.: US 2026/0267501 A1
(43) Pub. Date: Sep. 10, 2026

(54) System and Method for Generating Resource Management Data and Real-Time Rendering Thereof

(71) Applicant: Chewy, Inc., Plantation, FL (US)

(72) Inventors: Ryan Alamo, Miami, FL (US); Alexey Petrusevich, Boston, MA (US); Archana Sathya Navada, Cambridge, MA (US); Helen Liu, Dorchester, MA (US); Joseph Michael Nagy, Lanoka Harbor, NJ (US)

(73) Assignee: Chewy, Inc., Plantation, FL (US)

(21) Appl. No.: 19/167,003

(22) PCT Filed: Mar. 22, 2024
(86) PCT No.: PCT/US2024/021122

§ 371 Date: Sep. 19, 2025

Related U.S. Application Data
(60) Provisional application No. 63/491,993, filed on Mar. 24, 2023.

(51) Int. Cl. G06F 3/0486; G06F 3/0482; G06F 9/50

(52) U.S. Cl. CPC G06F 3/0486; G06F 3/0482; G06F 9/5055

(57) ABSTRACT

A system for generating and displaying a graphical user interface indicating the assignment of one or more resources to one or more tasks. The system includes a database and a fulfillment center (FC) server. The FC server generates an administrator facing user interface (UI) and a non-administrator facing UI. A client device receives and displays the administrator facing UI. A display device displays the non-administrator facing UI. The FC server detects input received at the client device and causes an association between resource specific data and task specific data, which correspond to a selected interactable icon and a location within a first task board display field, and updates a second task board display field of the non-administrator UI to include a graphical representation of the selected interactable icon at a location within the second task board display field corresponding to the location within the first task board display field.

### CROSS-REFERENCE TO RELATED APPLICATIONS

This application claims the benefit of U.S. Provisional Patent Application No. 63/491,993 filed Mar. 24, 2023 entitled “System and Method for Generating Resource Management Data and Real-Time Rendering Thereof”, which is incorporated by reference herein in its entirety.

### TECHNICAL FIELD

The present disclosure generally relates to systems and methods for real-time rendering and displaying resource management data.

### SUMMARY

In one embodiment there is a system for generating and displaying a graphical user interface indicating the assignment of one or more resources to one or more tasks, the system includes, a database having stored thereon resource specific data for a resource, task specific data for a task, task board specific data and department specific data, a fulfillment center (FC) server in communication with the database, the FC server configured to generate an administrator facing user interface (UI) including an interactable icon corresponding to resource specific data for the resource and a first task board display field including task locations corresponding to task specific data for the one or more task, the FC server further configured to generate a non-administrator facing UI including a second task board display field, a client device in communication with the FC server and configured to receive and display the administrator facing UI, the client device further configured to receive an input indicating a selection and movement of at least one of the interactable icons to a location within the first task board display field, a display device in communication with the FC server and configured to display the non-administrator facing UI including the second task board display field. The FC server is configured to in response to detecting the input received at the client device, automatically cause the database to create an association between resource specific data and task specific data correspond to the selected interactable icon and the location within the first task board display field, and update the second task board display field of the non-administrator UI to include a graphical representation of the selected interactable icon at a location within the second task board display field corresponding to the location within the first task board display field.

In some embodiments, the location within the first task board display field corresponds to the task specific data for the task. In some embodiments, the FC server is configured to automatically update the second task board display field in real time with the detected input received at the client device. In some embodiments, the FC server is further configured to update the second task board display field based on an association of the display device with the department specific data. In some embodiments, the FC server is configured to determine that a current date and/or time corresponds to a time period associated with the first task board display field and automatically update the second task board display field in response to the determination. In some embodiments, the FC server is configured to automatically cause a plurality of the display devices to render the updated second task board display field of the non-administrator UI simultaneously.

In another embodiment there is a method of generating and displaying a graphical user interface indicating the assignment of one or more resources to one or more tasks, the method includes at a fulfillment center (FC) server in communication with a database having stored thereon resource specific data for a resource, task specific data for a task, task board specific data and department specific data: generating an administrator facing user interface (UI) including an interactable icon corresponding to resource specific data for the resource and a first task board display field including task locations corresponding to task specific data for the one or more task, and generating a non-administrator facing UI including a second task board display field. The method includes at a client device in communication with the FC server receiving and displaying the administrator facing UI, receiving an input indicating a selection and movement of at least one of the interactable icons to a location within the first task board display field. The method includes at a display device in communication with the FC server, displaying the non-administrator facing UI including the second task board display field, and at the FC server in response to detecting the input received at the client device, automatically causing the database to create an association between resource specific data and task specific data corresponding to the selected interactable icon and the location within the first task board display field, and updating the second task board display field of the non-administrator UI to include a graphical representation of the selected interactable icon at a location within the second task board display field corresponding to the location within the first task board display field.

In some embodiments, the location within the first task board display field corresponds to the task specific data for the task. In some embodiments, the method further includes at the FC server, automatically updating the second task board display field in real time with the detected input received at the client device. In some embodiments, the method further includes at the FC server, updating the second task board display field based on an association of the display device with the department specific data. In some embodiments, the method further includes at the FC server, determining that a current date and/or time corresponds to a time period associated with the first task board display field and automatically updating the second task board display field in response to the determination. In some embodiments, the method further includes at the FC server, causing a plurality of the display devices to render the updated second task board display field of the non-administrator UI simultaneously.

### BRIEF DESCRIPTION OF THE DRAWINGS

The following detailed description of embodiments of the system and method, will be better understood when read in conjunction with the appended drawings of exemplary embodiments. It should be understood, however, that the invention is not limited to the precise arrangements and instrumentalities shown.

In the drawings:

FIG. 1 is a block diagram illustrating an implementation of a system for generating resource management data and real-time rendering thereof, in accordance with an exemplary embodiment of the present disclosure;

FIG. 2 is an entity relationship diagram illustrating an implementation of the database of FIG. 1;

FIGS. 3A-3J illustrates exemplary user interfaces for a method of generating and displaying an assignment of one or more resources to one or more tasks, in accordance with an exemplary embodiment of the present disclosure.

### DETAILED DESCRIPTION

In conventional warehouses and order fulfillment centers resources are typically assigned to one or more tasks or assignments throughout a given work period, also referred to as a shift. The tasks or assignments may be work tasks or areas of the fulfillment center that a resource (e.g., personnel) is assigned to. For example, some personnel (e.g., employees, contractors) may be assigned to a package assembly task for their shift and other personnel may be assigned to retrieve products from storage locations throughout the fulfillment center that are to be shipped out. Fulfillment center practice may require the assembly of a resource aggregation for a particular task. That resource aggregation may include a personnel package, a tools package and other resources (or resource packages) that may be allocated to a specific task, over a defined period, and/or for achieving a defined outcome. In some instances, the allocated resources change before the specific task, the defined period and/or the defined outcome is achieved or completed. For example, a resource may be allocated to a first task during a first time period (e.g., a first day) and then allocated a to a different task at a different time period (e.g., on a second day).

In some instances, resource capability and/or qualification is a factor in determining whether the resource is appropriately allocated to a task. For example, personnel may require specialized training to perform in connection with a task. In some embodiments, the system may be configured to facilitate the collection, retrieval and/or storage of data associated with resource capability and/or qualification. Embodiments of the system and method incorporate a rationale that is configured to ensure resource allocation based on capability is prioritized or ensured. In some embodiments, the system and/or method of the present disclosure may be implemented as part of a federated network. In some embodiments, the system(s) of the present disclosure may be configured to enable a plurality of users to access the functionalities thereof from a plurality of networked devices simultaneously and, in some instances, execute a method of the present disclosure.

Numerous details are described herein in order to provide a thorough understanding of the example embodiments illustrated in the accompanying drawings. However, some embodiments may be practiced without any of the specific details, and the scope of the claims is only limited by those features and aspects specifically recited in the claims. Furthermore, well-known methods, components, and circuits have not be described in exhaustive detail so as not to unnecessarily obscure pertinent aspects of the embodiments described herein.

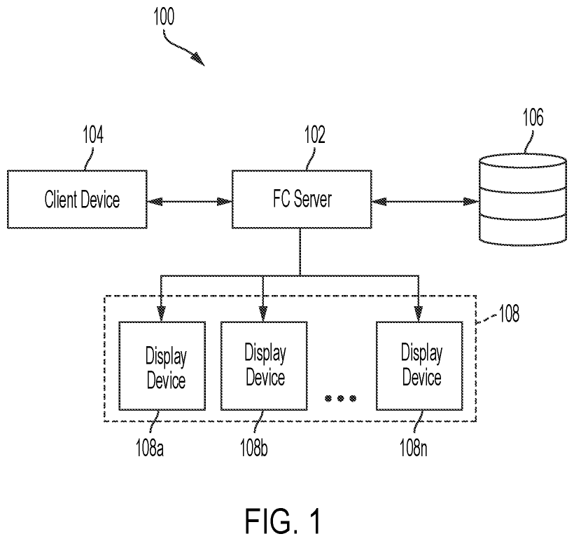

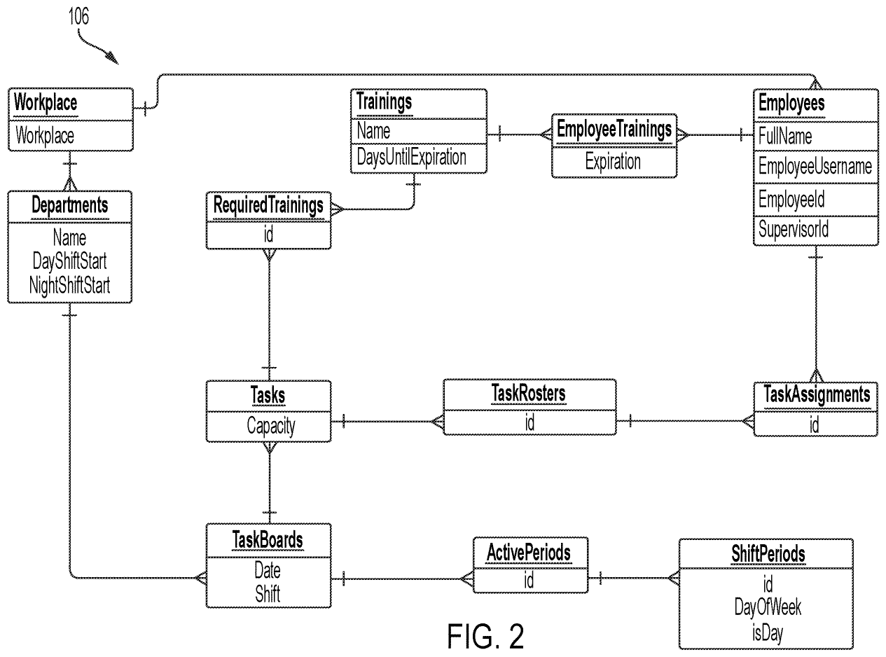

The systems and methods discussed herein may be configured to generate resource management data and an associated rendering thereof in real time. Some embodiments of the present disclosure provide improvements to generating and displaying an organized chart of work assignments by providing a system for assigning and displaying tasks configured to enable quick and efficient development and display of the organized chart. Referring to the drawings in detail, wherein like reference numerals indicate like elements throughout, there is shown in FIGS. 1-2 a system for generating resource management data and a real-time rendering thereof, generally designated 100, and alternatively referred to as system 100 for short, in accordance with an exemplary embodiment of the present disclosure.

In one embodiment, the system 100 includes one or more computers or computing devices having one or more processors and memory (e.g., one or more nonvolatile storage devices). In some embodiments, memory or computer readable storage medium(s) of memory store programs, modules and data structures, or a subset thereof, for a processor to control and run the various systems and methods disclosed herein. In one embodiment, a non-transitory computer readable storage medium having stored thereon computer-executable instructions which, when executed by a processor, performs one or more of any combination of the methods or steps disclosed herein.

Referring to FIG. 1, there is shown a block diagram illustrating an implementation of the system 100. While some example features are illustrated, various other features have not been illustrated for the sake of brevity and so as not to obscure pertinent aspects of the example embodiments disclosed herein. The system 100 may include a fulfillment center (FC) server 102, one or more client devices 104, one or more databases 106, and/or one or more display devices 108. The FC server 102 may include one or more computing servers that may be integrated by a network. In one embodiment, FC server 102 may include digital serverless functionality deployed via nodes at one or more locations. FC server 102 may be configured to provide secure access to an administrator facing user interface (UI), also referred to as admin UI, that is configured to generate a display of resource allocation assignments for a plurality of different resources (e.g., personnel and/or non-administrators) to a plurality of different tasks. Administrators, as referred to herein, may include users who have a managerial role within a given fulfillment center, warehouse, or other workplace. Administrators may generally be users who are responsible for the assigning of a number of resources (e.g., personnel) to a number of tasks. As such, non-administrators may generally refer to resources not responsible for assigning one or more other resources to specific tasks.

Tasks as referred to herein may include actions to be performed by resources. For example, tasks performed in an order fulfillment center may include, but are not limited to, the construction of packaging (e.g., boxes) to be used for shipping goods to customers, depalletizing bulk products, transporting depalletized bulk products to designated storage areas, retrieving products to be shipped to customers from storage areas, packaging products to be shipped to customers, and/or participating in task related training programs. In some embodiments, a task may associated with a working area within a facility where one or more work related actions are to take place. For example, one task may be to unload packages received at a first zone of a receiving dock and a second task may be to unload packages received at a second zone of the same receiving dock.

The FC server 102 may be configured to enable the generation and/or display of one or more task assignments at client device(s) 104 in communication with the FC server 102. The client devices 104 may be operated on any suitable computer device, such as, but not limited to, a computer, a laptop computer, a tablet device, a netbook, an internet kiosk, a personal digital assistant, a mobile phone, a smart phone, a gaming device, a computer server, or any other computing device. The FC server 102 may be configured to generate the admin UI such that it is accessible via the internet or over a local area network (LAN) and viewable at a respective client device 104. For example, the FC server 102 may be in communication with the one or more client devices 104 such that the FC server 102 may generate and transmit the admin UI to a client device 104 for display to a user (e.g., administrator).

The FC server 102 may be configured to transmit for display task assignment data for a plurality of different resources to one or more display devices 108. Resources, such as, but not limited to personnel (e.g., employees, contractors) may view the displayed task assignment data as needed and/or desired. For example, the FC server 102 is configured to receive inputs (e.g., from an administrator), via the admin UI, and generate the display of task assignments in the form of a graphical representation of the assignments. In some embodiments, a graphical representation of assignments may include, but is not limited to, a list of tasks and the resources assigned thereto, or a chart of the tasks and the resources assigned thereto. The FC server 102 may be configured to transmit the generated display of task assignments as a non-administrator facing UI to one or more display device 108 such that resources (e.g.,) personnel may view the generated display of task assignments at one or more display devices 108 and determine their respective assigned tasks for a given work period. As such, the FC server 102 may be in communication with the one or more display devices 108.

A generated display of task assignments according to the systems and embodiments described herein may be referred to as a “task board” that includes a visual indication of one or more tasks associated with a specific department and one or more resources assigned to those one or more tasks. For example, a task board may be a graphical user interface displaying data including an indication as to one or more tasks and the resources assigned to those tasks for a specific department. A department may refer to a specific division for dealing with a specific subject, commodity, or area of activity within a workplace. For example, in an instance where a workplace is a fulfillment center or warehouse, one department may be for quality control and inspection, another department may be for retrieving and storing incoming inventory, and another department may be for preparing outgoing orders. There may be a plurality of task boards each having task board associated data stored on the database 106. In some embodiments, there may be a plurality of task boards associated with a specific department. For example, there may be a task board for each working period (e.g., day shift, evening shift, night shift) of a department.

The FC server 102 may be configured to communicate with one or more databases (e.g., database 106) to receive and transmit data relating to task assignments for a plurality of resources and/or departments included in a workplace. The database 106 may be a relational database (see FIG. 2). In some embodiments, the database 106 includes a non-relational database. The database 106 may have stored thereon, department specific data, task specific data, and/or resource specific data. For each department having department specific data stored on the database 106, the department specific data may include, but is not limited to, data corresponding to a department name, an indication of a start time or end time for work periods (e.g., day shift and night shift start times) associated with the department, and a listing of all tasks associated with the department. The task specific data stored on database 106 may include, for each task, data corresponding to one or more required trainings to be eligible to perform the task, a minimum number of resources required to perform the task, a maximum number of resources that may perform the task simultaneously. The resource specific data may include, for each resource, data corresponding to the name of the personnel, the name of the personnel's supervisor or manager, a listing of all trainings completed by the personnel, a date each training was completed, an expiration date for each completed training, a unique resource identifier, and/or a listing of tasks the personnel prefers to be assigned to. The terms resource and personnel may be used interchangeably herein. The data stored on database 106 is described in more detail with reference to FIG. 2.

Referring to FIG. 2, there is shown an entity relationship (ER) diagram for database 106 in accordance with an exemplary embodiment of the present disclosure. The ER diagram in FIG. 2 may relate to how the department, resource, and task specific data are associated with one another. Database 106 may store data associated with one or more departments, one or more resources, and one or more tasks in tables. The database 106 may include a workplace table, department table, task boards table, active periods table, and shift periods table associated with department specific information. The database 106 may include a tasks table, a required training table, and a task rosters table associated with task specific data. The database 106 may include a trainings table, an employee trainings table, an employees table, and a task assignments table associated with resource specific data.

The workplace table may include data associated with one or more workplaces. The departments table may include data associated with a department name, and an indication of work periods (e.g., the start time for different work periods such as a day shift and a night shift). The departments table may include a plurality of departments each having associated department data and one or more relationships to one or more workplaces. For example, the database 106 may include an indication as to the departments included in a specific workplace. The task boards table may include data relating to one or more task boards. For each task board, the data relating thereto may include a unique task board identifier, data corresponding to the date of the task board (e.g., the date that the task board is intended to be or was previously used) and a work period (e.g., an indication of which shift the task board is for). In some embodiments, the database 106 has stored thereon an indication of which task boards are associated with which departments.

The active periods table may include data relating to one or more unique identifier for associating activity periods with one or more task boards. The shift periods table may include one or more unique identifiers, an indication as to the days of a week that a working period occurs, and an indication as to the current date. The active periods table and shift periods table may generally include data that may be used by the FC server 102 to determine, based on a current date and/or time of day, what task boards to transmit for display to one or more display devices 108.

The tasks table may include data relating to a maximum number of resources for each task. In some embodiments, the tasks table includes data relating to a minimum and/or preferred number of personnel for each specific task. The task rosters table may include a unique identifier for each task having task specific information stored on the database 110. In some embodiments, the database 106 includes an indication as to the association of tasks with different task boards. For example, the tasks table and/or task rosters table may include an indication as to the association of tasks included in a specific task board. The required trainings table may include data relating to trainings required for performing a specific task. For example, a task requiring the operation of a fork truck may require that personnel assigned to operate a fork truck have completed training for, and are certified in, operating the fork truck. As a further example, a task of assembling packaging (e.g., boxes) may require that personnel assigned to that task have completed a training course in a preferred manner of assembling and taping the packaging.

The employees table may include data for each resource in a specific workplace. The data for each resource, or personnel, may include an indication of their name, a workplace specific username and/or unique identifier, and an indication as to the supervisor of the specific personnel. The employee trainings table may include data relating to the expiration date of trainings completed by one or more personnel. The trainings table may include data relating to the name of one or more different trainings and the number of days remaining until expiration for each of the one or more trainings. The trainings and employee trainings tables may include data relating to which personnel have completed which trainings and, of those completed trainings, which ones have expired and which ones have not. The task assignments table may include data relating to a unique identifier for one or more tasks assigned to specific personnel. For example, the task assignments table may include data indicating that a first personnel is assigned to a first task and that a second personnel is assigned to a second task. In some embodiments, the task assignments table may be updated in response to an administrator assigning resources (e.g., personnel) to tasks via the admin UI, discussed in more detail below.

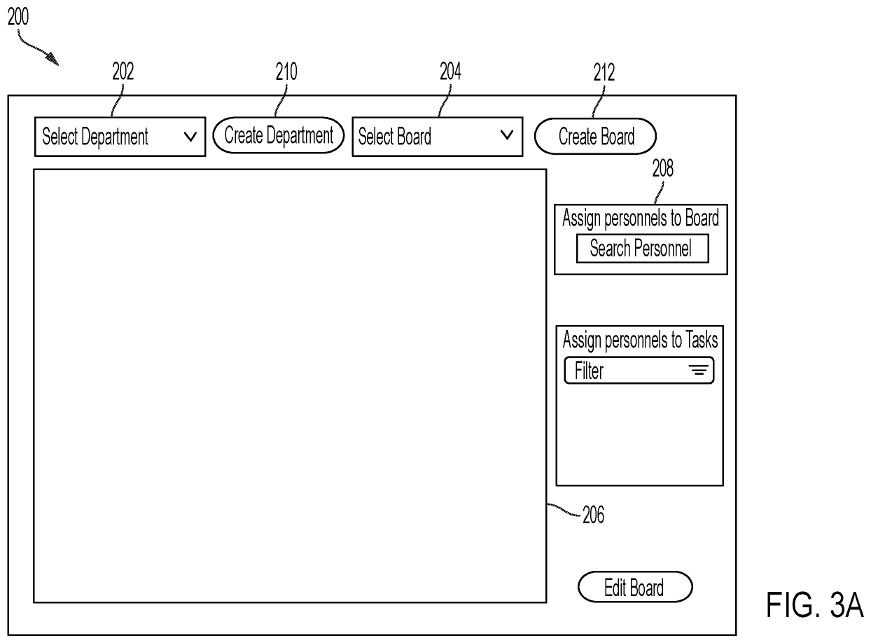

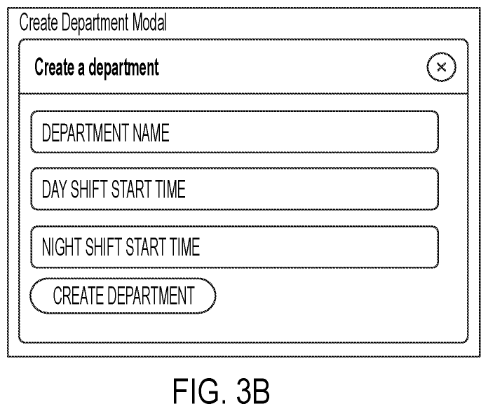

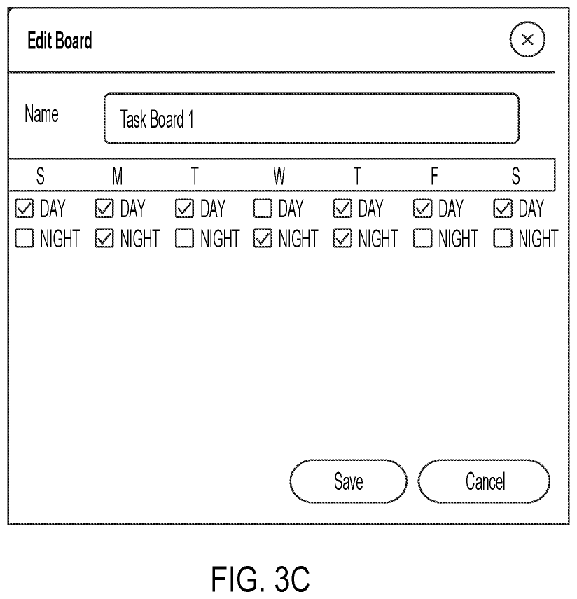

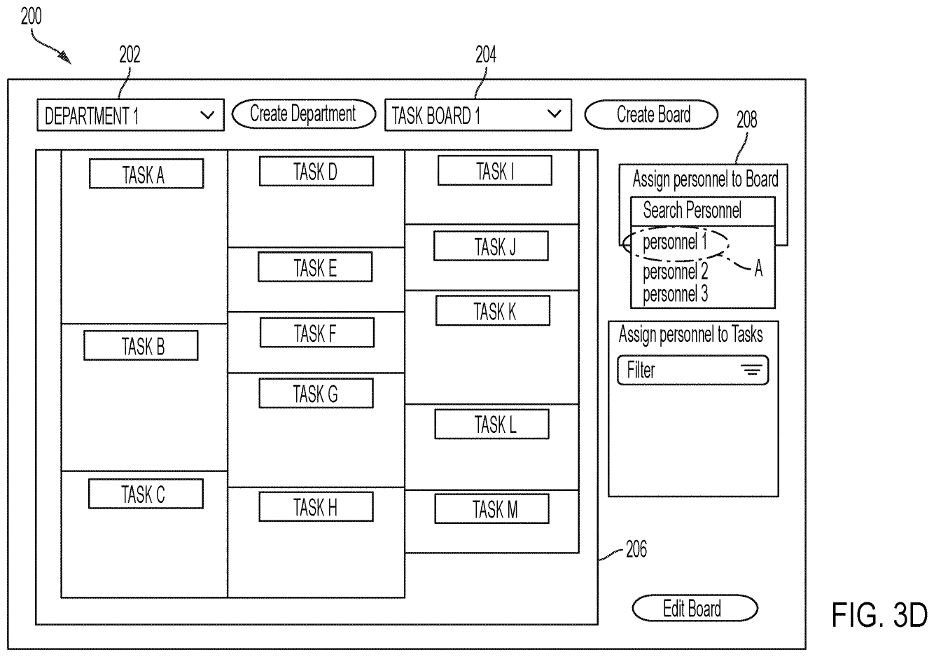

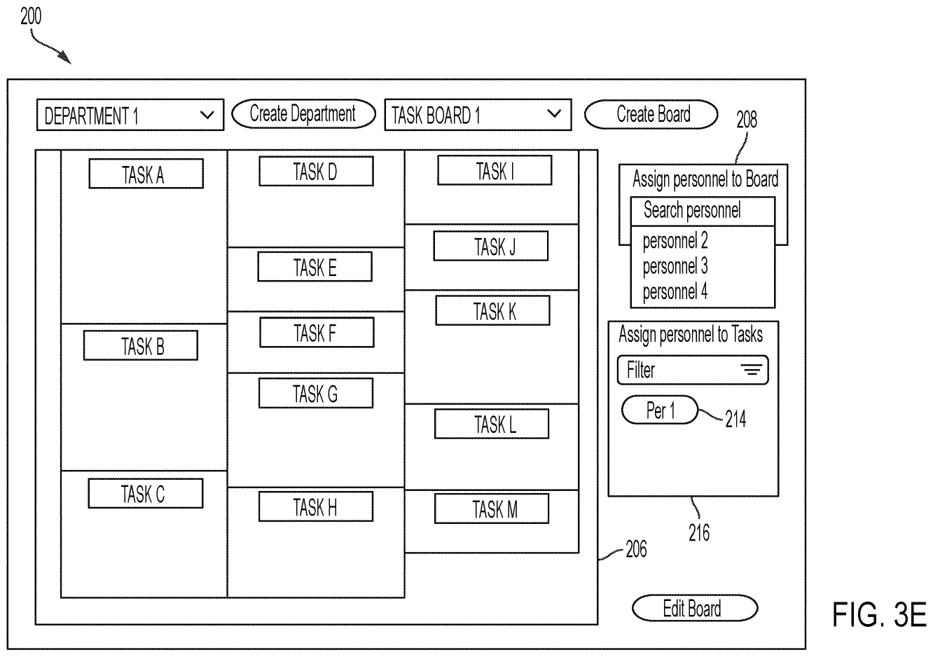

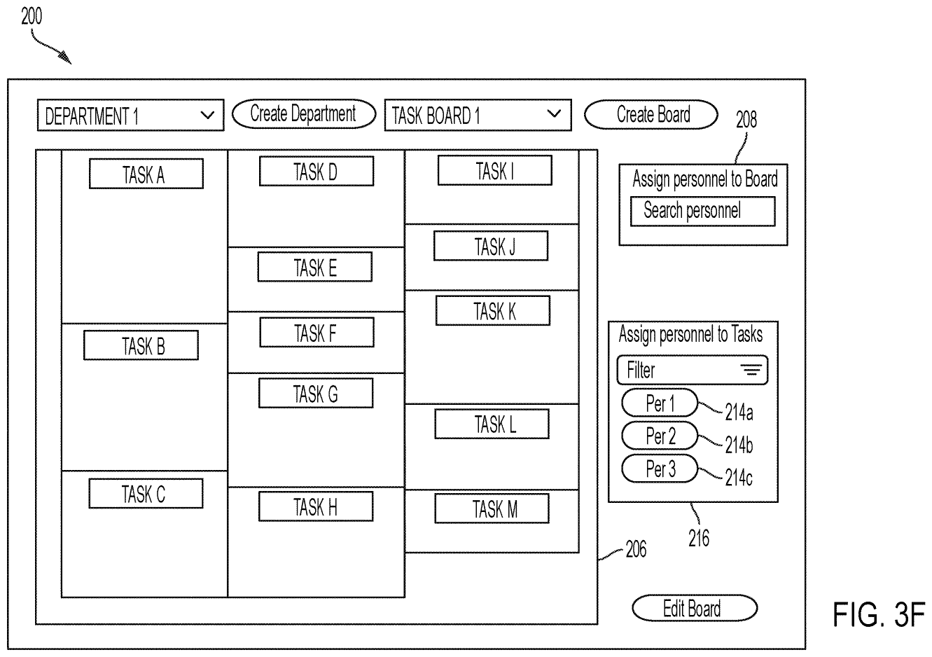

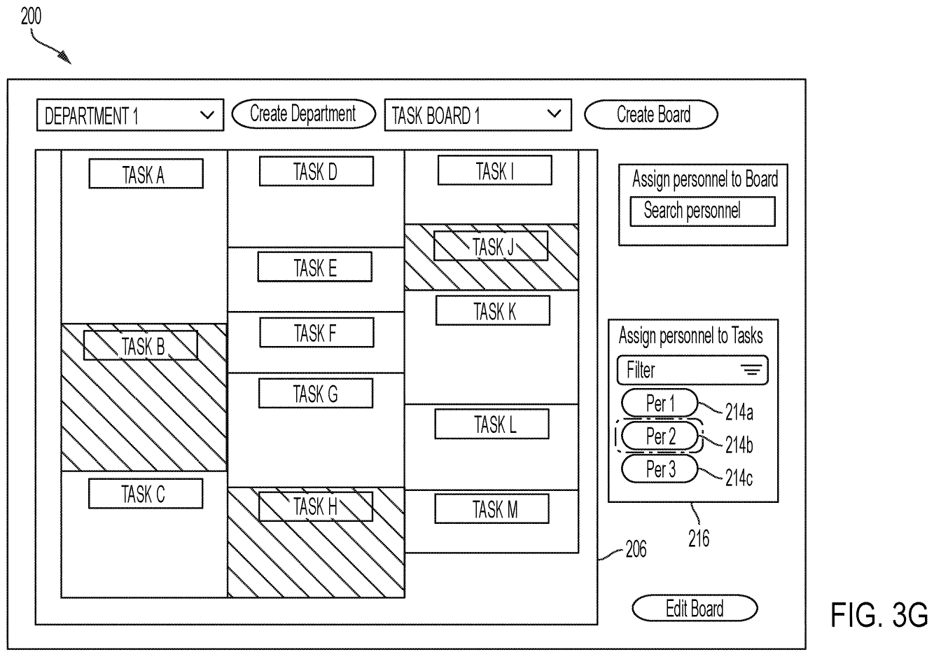

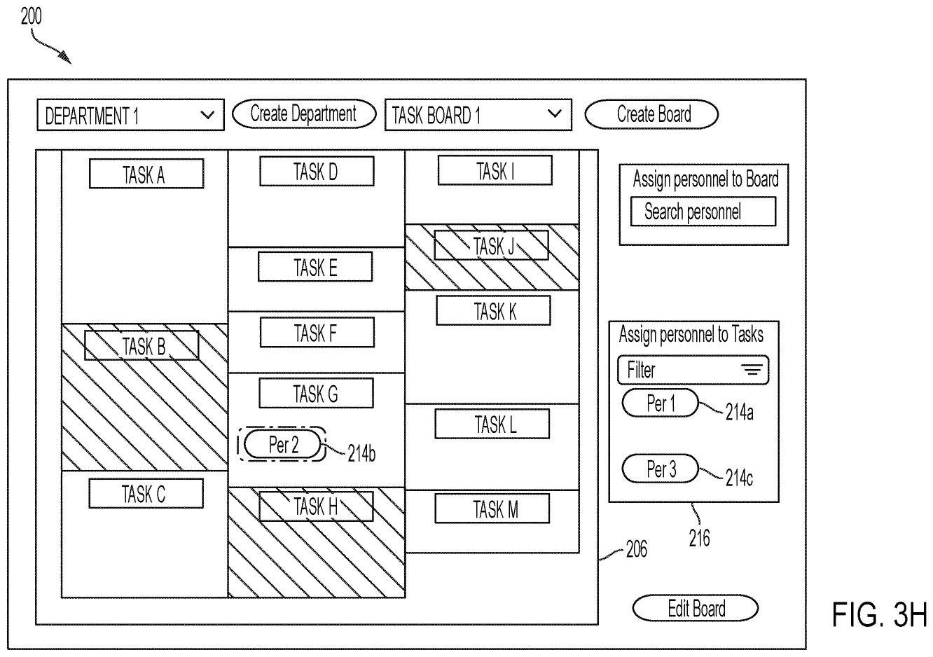

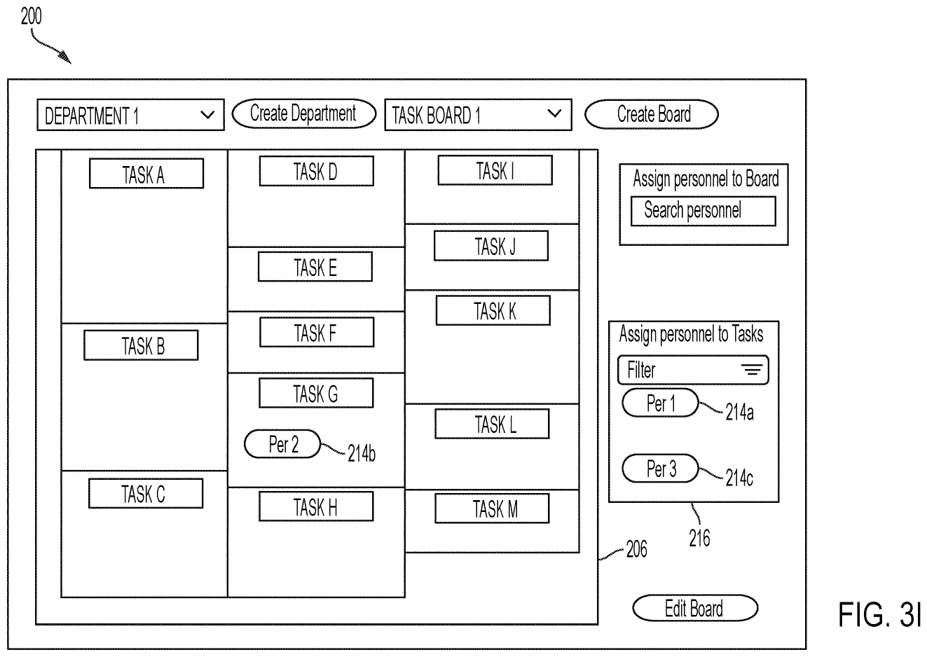

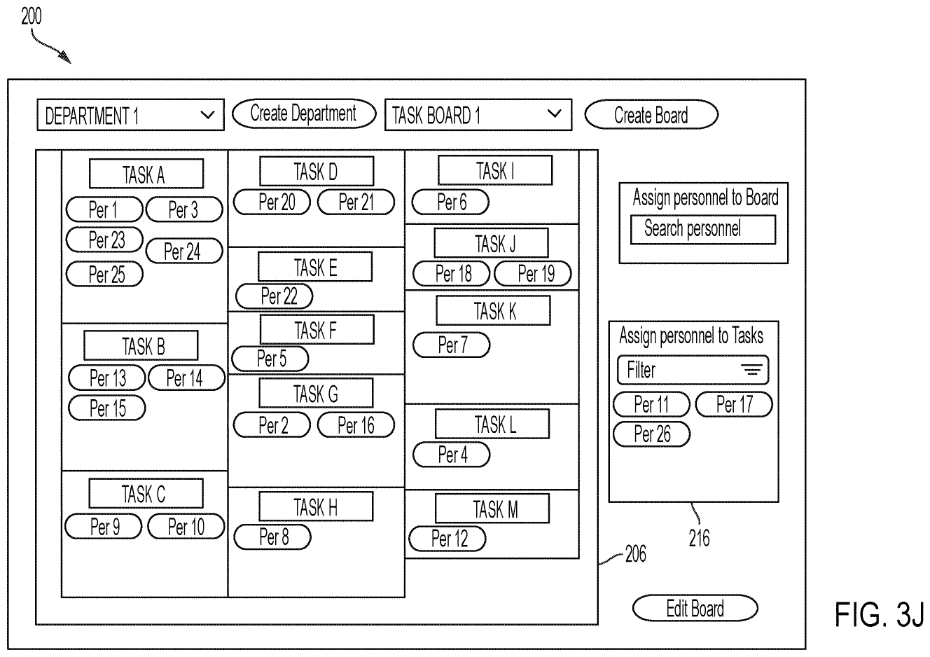

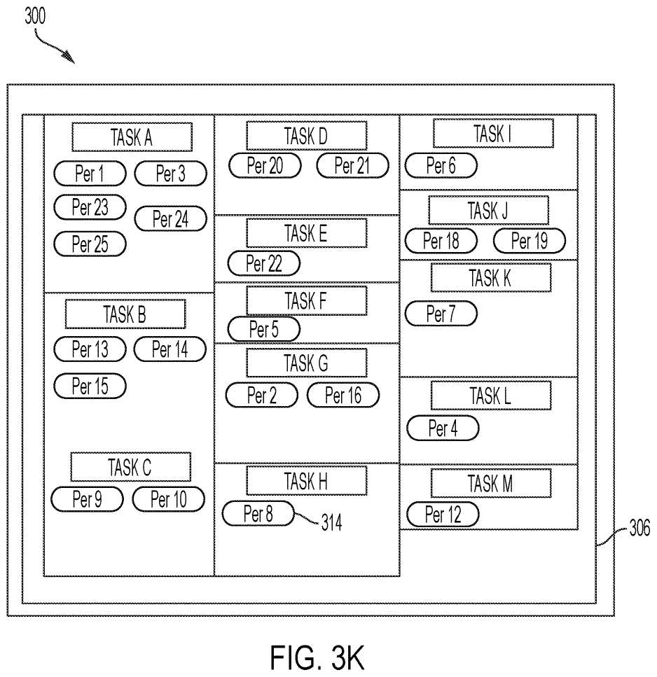

Referring to FIGS. 3A-3J there is illustrated exemplary user interfaces for generating a display including a visual indication of one or more task assignments. The exemplary user interfaces illustrated in FIG. 3A-3J are intended to represent an admin UI, generally designated 200, displayed on a client device 104. In some embodiments, the FC server 102 is configured to generate and transmit the admin UI 200 to a plurality of client devices 104 simultaneously. Prior to the admin UI 200 being displayed at the client device 104, the client device 104 may receive one or more inputs causing the client device 104 to transmit a request to the FC server 102 for the admin UI 200. For example, a user (e.g., an administrator) may navigate to website or open a software application on the client device 104 in order to display the admin UI 200 at the client device 104. In some embodiments, two or more user may display the admin UI 200 at respective client devices 104 communicatively coupled to the FC server 102. In response to receiving the request, the FC server 102 may transmit the admin UI 200 to the client device 104 for display. Various aspects of the exemplary system and methods discussed herein are illustrated with reference to the exemplary user interfaces discussed herein. Furthermore, the exemplary user interfaces are described with reference to one or more users (e.g., administrators, non-administrators) selecting graphical elements or fields displayed at the user interfaces. It will be understood that a selection at a graphical element (e.g., an input field or selection field) displayed at an exemplary UI refers to the FC server 102 detecting one or more inputs at the client device 104 corresponding to that graphical element. For example, a selection may be a user input at a peripheral input device (e.g., a mouse, a keyboard, touch screen, voice command received via microphone) in order for the user to interact with elements of the admin UI 200.

Referring to FIG. 3A, the admin UI 200 is illustrated as displayed on a client device 104 which may be operated by a user (e.g., an administrator). The admin UI 200 may include a department selection field 202, a task board selection field 204, a task board display field 206, and personnel search field 208. The department selection field 202 may enable the selection of a specific department from a list of one or more departments included in a workplace. In some embodiments, the department selection field 202, when selected, may display a list of all departments having department specific data stored on database 106 for a specific workplace. For example, if the workplace that the user is associated with includes three different departments, then the department selection field 202 may display a listing of those three different departments to the user. The task board selection field 204 may enable the selection of a specific task board from a list of one or more task boards associated with the selected department. In some embodiments, the task board selection field 204, when selected, may display a list of all task boards having task board specific data stored on database 106 that is associated with the selected department. For example, in response to a selection of a first department at the department selection field 202 and a selection of the task board selection field 204 the FC server 102 may be configured to cause the task board selection field 204 to display a list of all task boards associated with the first department and having task board specific data stored on database 106. In some embodiments, the FC server 102 is configured to require that a department is selected before allowing the selection of a specific task board.

In some embodiments, the admin UI 200 may include a department creation button 210 and/or a task board creation button 212 to enable the input of data for a department and/or task board that has no corresponding data stored on database 106 (e.g., for a new department and/or task board). In response to the FC server 102 detecting selection of the department and/or task board creation buttons 210, 212 the FC server 102 may cause the admin UI 200 to display a prompt for data input corresponding to a new department and/or task board. In response to receiving the input new department and/or task board data the FC server 102 may be configured to transmit that data to the database 106 for storage. In some embodiments, in response to the FC server 102 detecting a selection of the department creation button 210, the FC server 102 is configured to cause the admin UI 200 to display at a client device 104 the UI window shown in FIG. 3B. The FC server 102 may be configured to detect inputs at the UI window shown in FIG. 3B, corresponding to department specific information for the new department. For example, the FC sever 102 may detect inputs, such as those generated by a user (e.g., administrator) of the client device 104, corresponding to the department name and a start time for one or more working periods (e.g., day shift and night shift start times). In some embodiments, in response to the selection of the task board creation button 212, the FC server 102 is configured to cause the admin UI 200 to display the UI window shown in FIG. 3C. The FC server 102 may be configured to enable a user (e.g., administrator) to input at the UI window shown in FIG. 3C, task board specific information for the new task board. For example, an administrator may input a task board name, and an indication of which days of the week and/or which working periods the task board is intended to apply to. The FC server 102 may be configured to receive the information input by the administrator at the UI window shown in FIG. 3C and automatically transmit the input information to the database 106 for storage.

Still referring to FIG. 3A, the task board display field 206 may enable a user (e.g., an administrator) to view and interact with a selected task board. For example, the FC server 102 may be configured to detect a selection of a task board from the task board selection field 204, and in response to detecting the selection generate a rendering of the selected task board at the task board display field 206 based on the corresponding task board specific information stored on database 106. The FC server 102 may be configured to enable a user (e.g., an administrator) to view and interact with the task board displayed at the task board display field 206 (shown in FIG. 3D). The personnel search field 208 may enable an administrator to search for one or more resources, such as personnel including, but not limited to, employees and/or contractors, that the administrator wishes to associate with the selected task board. For example, the FC server 102 is configured to detect an interaction with the personnel search field 208 and cause the search field 208 to display a listing of all personnel having resource specific information stored on database 106. For example, in response to detecting an input at the personnel search field 208, the FC server 102 may be configured to cause the admin UI 200 to display, at the personnel search field 208, a list of the names of all personnel having resource specific information stored on database 106.

In some embodiments, the FC server 102 is configured to automatically filter the list of personnel names based on the selected department. For example, the FC server 102 may be configured to determine a listing of personnel associated with a selected department based on resource and department specific information stored on database 106. In response to detecting a selection at the personnel search field 208, the FC server 102 may be configured to cause the admin UI 200 to render, at the personnel search field 208, the listing of personnel associated with the department selected at the department selection field 202. In some embodiments, the FC server 102 is configured to automatically filter the list of personnel names displayed at the personnel selection field 208 based on the task board selected at the task board selection field 204. For example, the FC server 102 may be configured to selectively display only personnel having associated resource specific data stored on the database 106 indicating that the personnel is not currently associated with another task board. For example, resource specific data stored on the database 106 may include an indication as to one or more personnel associated with a task board (e.g., task board 2) different from the task board selected at selection field 204 (e.g., task board 1). Further to this example, in response to the FC server 102 detecting a selection of a task board at selection field 204 and an interaction with the employee search field 208, the FC server 102 may cause the list of personnel displayed at the personnel search field 208 to omit the name of the personnel associated with the other task board (e.g., task board 2). The FC server 102 may be configured to filter a listing of available personnel displayed at the admin UI 200 to easily enable the a user (e.g., administrator) viewing and/or interacting with the admin UI 200 to avoid conflicts when assigning personnel to different task boards.

Referring to FIG. 3D, the FC server 102 has detected a selection of a department (e.g., “Department 1”) and a task board (e.g., “task board 1”) at the respective department and task board selection fields 202, 204. In response to detecting a selection of a specific department and specific task board at the corresponding fields 202, 204, the FC server 102 may be configured to render task board specific data associated with the selected task board at the task board display field 206. For example, as illustrated in FIG. 3D, the task board display field 206 includes a graphical display of task board specific data for task board 1 including one or more task fields. In FIG. 3D, there are a plurality of task fields each corresponding to a different task to which resources may be assigned. The FC server 102 may be configured to determine the task fields to be displayed based on task board specific data and task specific data stored on database 106. The task board specific data may include an indication as to the number of tasks associated with a specific task board and/or a unique identifier for each task associated with the specific task board. For example, in FIG. 3D the FC server 102 is configured to determine, based on the task board specific data stored on database 106 associated with the selected department and task board at fields 202, 204, that there are thirteen tasks associated with the selected task board.

In some embodiments, the FC server 102 is configured to cause the admin UI to render tasks at the task board display field 206 based on department specific data and/or a current working period. The department specific data that is stored in database 106 may include an indication of working periods associated with that department (e.g., day shift, night shift). In some embodiments, the department specific data includes, for each associated working period, an indication of the tasks associated with the working period. For example, the department specific data may include an indication for a first working period (e.g., a day shift) that there are thirteen different tasks (e.g., tasks A-M) and for a second working period (e.g., a night shift) that there are ten different tasks (e.g., tasks A-J). The FC server 102 may be configured to detect a selection of one or more working periods for a selected task board. For example, the FC server 102 may be configured to detect a selection of the working periods (e.g., day shift, night shift) for different days of the week (e.g., Sunday through Saturday) as illustrated in, for example, FIG. 3C. In FIG. 3C, the selected working periods detected by the FC server 102 for Department 1 and Task Board 1 are day shifts for Sunday, Monday, Tuesday, Thursday, Friday and Saturday, and night shifts for Monday, Wednesday, and Thursday.

The FC server 102 may be configured to determine, at the time at which the admin UI 200 is rendered in FIG. 3D, that the current date and time coincide with the Monday day shift for Department 1. As such, in FIG. 3D, the FC server 102 may be configured to automatically retrieve, from the database 106, task specific data for tasks associated with the current working period for the selected department. For example, in FIG. 3D, the FC server 102 is configured to automatically retrieve from the database 106 the task specific data for tasks A-M from the database 106 and render the task specific data at the admin UI 200. in some embodiments, the FC server 102 is configured to, in response to detecting an input indicating that a new department field is created, automatically associate one or more tasks with the new department. In response to detecting a user input at the department creation button 210, the FC server 102 may cause the admin UI 200 to render one or more input fields (e.g., as shown in FIG. 3B) corresponding to department specific data for a new department. The one or more input fields may include, but are not limited to, a department name, working periods (e.g., day shift start time, night shift start time), department type, and department location. The FC server 102 may be configured to detect inputs at the input fields and transmit a request to the database 106 to store the input department specific data for the new department. The FC server 102 may also be configured to automatically determine, based on the input department specific data, one or more expected tasks for the new department. For example, the new department may be a receiving department intended to handle the introduction of palletized products into a storage facility. As such, the input department specific data may include, in the department name, the text “Receiving.” Further to this example, the FC server 102 may be configured to automatically associate tasks such as, but not limited to, unloading palletized products from a shipping container, product inspection, quantity verification, updating warehouse inventory records, and/or transporting received products to designated storage locations within the warehouse. The FC server 102 may be configured to, in response to determining one or more tasks to associate with the new department, transmit a request to the database 106 to associate the corresponding department specific data with the task specific data for the determined one or more tasks. In this manner, the FC server 102 may enable a user to easily create a new department field at the admin UI 200 and automatically associate the new department field with one or more tasks.

The FC server 102 may further retrieve for each associated task, the corresponding task specific information stored on database 106. In this manner, the FC server 102 may be configured to automatically generate a display of the task fields including a visual indication of the name of the task (e.g., “Task A”, “Task B”, and so on). For example, for each associated task specific information, the FC server 102 is configured to generate a task field displayed on the task board display 106 including the name of the task. In FIG. 3D there is shown thirteen different task fields corresponding to tasks A-M.

The FC server 102 may be configured to enable the administrator to associate resource specific data for one or more resources (e.g., personnel) with task board specific data for the task board displayed at the task board display field 206. For example, the administrator may interact with the personnel search field 208 to begin associating resource specific data for one or more personnel with the displayed task board data. The administrator may select a personnel name displayed at the employee search field 208. For example, in FIG. 3D, the administrator may provide a user input at the location A at the personnel search field 208 that corresponds to a specific resource (e.g., personnel 1).

Referring to FIG. 3E, in response to the FC server 102 detecting a selection of a personnel to associate with the displayed task board, the FC server 102 may be configured to associate the resource specific data for the selected personnel with the task board specific data for the displayed task board. For example, in response to the FC server 102 detecting a selection at location A in FIG. 3D, the FC server 102 may cause the database 106 to associate the resource specific data for personnel 1 with the task board specific data for task board 1. Associating the resource specific data for personnel with task board specific data may include causing, by the FC server 102, the database 106 to be updated to include the association of the respective personnel specific data with the corresponding task board specific data. For example, in response to detecting the selection of personnel 1, the FC server 102 may transmit a request to the database 106 to cause the task board specific data to include an indication that personnel 1 is associated with the task board and is currently not associated with a specific task. In some embodiments, the FC server 102 is configured to generate an interactable icon 214 specific to the selected personnel in response to detecting a selection of a personnel name displayed at the personnel search field 208. For example, in FIG. 3E, the FC server 102 may be configured to render an interactable icon 214 that includes a visual indication of the selected personnel (e.g., “Per 1” for “Personnel 1”) at a personnel assignment field 216. Although the interactable icon 214 includes the text “Per 1” and the personnel names displayed at the personnel search field 208 are generically illustrated as “personnel #” it will be understood that the icon and list may alternatively include a visual indication of the personnel's name (e.g., they may be displayed as including the personnel's first and last name).

The personnel assignment field 216 may provide a visual indication that one or more personnel are associated with the displayed task board, but have not been assigned to a specific task included therein. For example, in FIG. 3E, the FC server 102 has caused the database 106 to create an association between personnel 1 and task board 1. However, personnel 1 has not been associated with, or assigned to, a specific task. As such, in FIG. 3E, the FC server 102 may not cause the resource specific data for the selected personnel to be associated with any task specific data for one or more of the tasks displayed at the task board display field 206.

Referring to FIG. 3F, the administrator 102 may repeat the process illustrated in FIGS. 3D-3E any number of times to cause the FC server 102 to associate resource specific data for any number of personnel with the task board specific data for the selected task board. For example, in FIG. 3F, the administrator has repeated the process illustrated in FIGS. 3D-3E twice by selecting personnel 2 and personnel 3 from the personnel search field 208. As such, the FC server 102 may cause the database 106 to associate the resource specific data for personnel 2 and 3 with the task board specific data for task board 1. The FC server 102 may further cause the admin UI 200 to display, at the personnel assignment field 216, interactable icons 214b and 214c corresponding to the selected personnel 2 and 3. Although three interactable icons 214a-214c are illustrated in FIG. 3F, it will be understood that any number of interactable icons may be displayed at the personnel assignment field 216.

Referring to FIGS. 3G-3H, the FC server 102 may be configured to associate resource specific data for one or more personnel with task specific data for one or more tasks in response to detecting interactions with the interactable icons 214. The FC server 102 may be configured to detect a selection of an interactable icon 214 (e.g., as shown in FIG. 3G) displayed at the personnel assignment field 216. In response to detecting the selection of an interactable icon 214, the FC server 102 may be configured to enable a user (e.g., administrator) to position (e.g., as shown in FIG. 3H) the selected interactable icon 214 at a location at the task board display field 206. Put another way, the FC server 102 may be configured to enable a user to drag-and-drop one or more interactable icons 214 at one or more different task fields. In some embodiments, the FC server 102 is configured to, in response to the FC server 102 detecting the selection of an interactable icon 214, generate a visual indication at the admin UI 200 of tasks the personnel associated with the selected icon is trained for. For example, in FIG. 3G, the FC server 102 detects the selection of the second interactable icon 214b corresponding to the resource specific data, stored on database 106, for “personnel 2”.

The FC server 102 may be configured to determine completed training data corresponding to the task trainings a personnel has completed, based on the resource specific data stored on database 106 corresponding to the selected interactable icon (e.g., the second interactable icon 214b). For example, in response to detecting the selection of the interactable icon 214, the FC server 102 may query database 106 to generate completed training data including a list of all trainings that personnel 2 has completed and that are not expired. The FC server 102 may be configured to determine required training data based on task specific data associated with the one or more tasks displayed at the task board display field 206. For example, the FC server 102 may query the database 106 to generate required training data including a listing of all trainings indicated in the task specific data stored on database 106 for the tasks displayed at the task board display field 206. The FC server 102 may compare the completed training data to the required training data to determine which of the displayed tasks the employee is trained for. For example, in FIG. 3G the FC server 102 is configured to determine, based on the completed training data associated with employee 2 and the required training data, that personnel 2 has not completed the required training associated with Task B, Task H, and Task J displayed at the task board display field 206.

In response to determining which of the displayed tasks the selected personnel is trained for, or not trained for, based on the corresponding data stored in database 106, the FC server 102 may be configured to cause the admin UI 200 to display a visual indication to of which tasks the selected personnel is trained for. For example, the FC server 102 may be configured to cause the task display fields for untrained tasks to be different from the task display fields for the remaining trained tasks. For example, in FIG. 3G, the FC server 102 determines, based on resource specific data for the selected personnel (e.g., personnel 2) and task specific data, that personnel 2 is not trained for tasks B, H, and J. As such, the FC server 102 may be configured to cause the task fields for tasks B, H, and J to include a gray fill color thereby providing a visual indication at the admin UI 200 that personnel 2 is not trained for those specific tasks. In this manner, the FC server 102 may significantly improve a user's ability to assign different resources (e.g., personnel) to different tasks by automatically determining what tasks different personnel are trained for.

Although in FIG. 3G, the visual indication relating to tasks the personnel is trained for is illustrated as a gray fill for untrained or unqualified tasks, it should be understood that any other visual indication may be used. For example, in other embodiments, the FC server 102 may be configured to cause task display fields corresponding to tasks a selected personnel is trained for to be filled with a green or yellow color.

As mentioned above, the FC server 102 may be configured to associate resource specific data for one or more selected resources (e.g., personnel) with task specific data for one or more tasks. For example, in FIG. 3H, the FC server 102 has detected the movement of the second interactable icon 214b associated with the resource specific data for personnel 2 into the task display field for task G. As such, in FIG. 3H the FC server 102 may be configured to transmit a request to the database 106 to update the task board specific data stored thereon to include an indication that personnel 2 is associated with task G. The FC server 102 may be configured to determine that, in FIG. 3H, the second interactable icon 214b is selected and as such, cause the rendered visual indication as discussed above with reference to FIG. 3G to remain active. For example, the administrator, in FIGS. 3G and 3H has clicked and dragged the second interactable icon 214b but has not placed or finished moving the second interactable icon 214b and as such the FC server 102 is configured to continue displaying the visual indication of training qualifications. In some embodiments, the FC server 102 is configured to prevent the placement of an interactable icon 214 into a task display field for a task that a associated personnel is not trained for. For example, and as discussed above with reference to FIG. 3G, the FC server 102 determined that personnel 2 was not trained for tasks B, H, and J. As such, the FC server 102 may prevent the placement, or repositioning of the second interactable icon 214b within the task display fields corresponding to tasks B, H, and J.

In FIG. 3I, the FC server 102 detects the placement of the second interactable icon 214b and within the task display field corresponding to task G. In response to detecting the placement of an interactable icon 214 within a task display field, the FC server 102 may be configured to associate the resource specific data for the selected personnel with task specific data based on the placement of the corresponding interactable icon 214 within the task board display field 206. For example, in FIG. 3I, the FC server 102 detects the placement of the second interactable icon 214b at a location within the task board display field 206 corresponding to task G. In response to detecting the placement of the second interactable icon 214b at the task display field for task G, the FC server 102 may cause the database 106 to create an association between the resource specific data corresponding to the second interactable icon 214b (e.g., resource specific data for personnel 2) and the task specific data corresponding to task G. The FC server 102 may be configured to generate a graphical user interface (e.g., admin UI 200) that enables a user (e.g., administrator) to easily and quickly associate resources (e.g., personnel) with one or more tasks.

Referring to FIG. 3J, the FC server 102 may be configured to automatically associate resource specific data for a plurality of resources with task board specific data and task specific data stored on database 106 and associated with a specific task board in response to detecting a user (e.g., administrator) input. As illustrated in FIG. 3J, the FC server 102 detects the selection, movement, and placement of interactable icons 214, as illustrated in FIGS. 3D-3I repeated a number of times and as such creates associations between resource specific data and task specific data stored on database 106. For example, in FIG. 3J, the FC server 102 has detected the interaction of a plurality of interactable icons 214 causing each to be placed at different locations within the task board display field 206 while a remaining number of interactable icons remain located within the personnel assignment field 216. The FC server 102 may enable the user (e.g., administrator) to quickly and easily generate a display of task assignments for one or more resources (e.g., personnel) to one or more different tasks and automatically associate the corresponding data in response thereto.

In some embodiments, the FC server 102 is configured to detect the selection of an interactable icon 214 and render a visual indication at the administrator facing UI 200, of one or more resource preferred tasks corresponding to the selected icon 214. For example, and referring back to FIGS. 3G-3H, in response to the FC server 102 detecting the selection of the second interactable icon 214b, the FC server 102 is configured to determine whether there is an indication of one or more preferred tasks included in the corresponding resource specific data. In response to determining that there is an indication of one or more preferred tasks in the corresponding resource specific data, the FC server 102 may cause the admin UI 200 to provide a visual indication of the preferred tasks. For example, if the resource specific data corresponding to the selected interactable icon (e.g., second interactable icon 214b) includes an indication that task A is a preferred task, the FC server 102 may cause the task display field within the task board display field 206a corresponding to task A to change in color or display text or indicia indicating that task A is a preferred task for personnel 2.

In some embodiments, the FC server 102 is configured to determine a minimum or preferred number of resources for each task displayed at the task board display field 206. For example, task A and task B may each have corresponding task specific data stored on database 106 that includes an indication that the minimum or preferred number of employees to be assigned to those tasks is five and two respectively. As such, the FC server 102 is configured to determine the minimum or preferred number and cause the admin UI 200 to provide a visual indication of the same. For example, the visual indication may be displaying the minimum or preferred number, displaying text indicating a remaining number of resources to be assigned (e.g., “assign two more personnel”), and/or displaying a color gradient where the colors included in the gradient represent the difference between the number of currently assigned resources and the determined minimum or preferred number (e.g., green for the difference being zero and red for the absolute value of the difference being greater than two).

In some embodiments, the FC server 102 is configured to determine a maximum number of resources that can be assigned to each task displayed at the task board display field 206 and having associated task specific information stored on database 106. For example, task A and task B may each have task associated data stored on database 106 that includes an indication that the maximum number of resources that can be assigned to those tasks is ten and five personnel respectively. As such, the FC server 102 is configured to determine the maximum number and cause the admin UI 200 to render a visual indication of the same. For example, the visual indication may be displaying the maximum number, displaying text indicating a remaining number of resources (e.g., “you can assign up to four more personnel to this task”), or displaying a color gradient where the colors included in the gradient represent the difference between the number of currently assigned resources and the determined maximum number (e.g., green when at up to 60% of the maximum number of assignments have been filled, yellow when between 60%-99%, and red when at 100% of the maximum number).

Referring to FIGS. 3D and 3J, in some embodiments, the FC server 102 is configured to detect a selection of a department and task board via UI 200 and in response to that selection automatically assign one or more resources to one or more tasks. For example, the FC server 102 in response to detecting the selection of Department 1 and Task Board 1 at the corresponding selection fields 202, 204 in FIG. 3D may automatically assign personnel to the tasks as shown in FIG. 3J. In some embodiments, the FC server 102 is configured to automatically determine which resources to assign to which tasks based on data received from one or more external sources. External sources, as referenced herein, may refer to one or more servers, web-based applications, cloud computing servers, databases that are in communication with the FC server 102 or any combination thereof. In some embodiments an external source (e.g., an external server) may be a source that is not directly controlled by or in common with the FC server 102. For example, the inputs and outputs of an external source may be independent of any inputs or outputs of the FC server 102.

In some embodiments, the FC server 102 is configured to receive, from an external source (e.g., external server), data relating to one or more pending tasks to be completed. For example, the external source may be configured to generate and transmit data relating to different tasks or actions that have not yet been completed (e.g., pending task data). In some embodiment the pending task data may include a task identifier for each task to be completed and, in some instances, a quantity associated with each task identifier. For example, the pending task data may include a task identifier associated with the construction of shipping containers and a quantity value of two-hundred indicating that there are two-hundred shipping containers to be constructed. Some further examples of pending task data associated with pending tasks or actions may include, but are not limited to, a number of palletized products to be sorted and transported to storage, a number of products to pull from storage for shipping, and a number of shipping labels to be printed. The FC server 102 may be configured to automatically determine, based on the received pending task data, a number of tasks to be completed during an upcoming working period and assign resources (e.g., personnel) to those tasks.

For example, the FC server 102 may be configured to automatically determine, based on the received pending task data that there are two-hundred shipping containers that need to be constructed during an upcoming working period (e.g., the next upcoming working period). In response to determining the tasks to be completed during the next working period, the FC server 102 may be configured to determine a number of personnel to be assigned to those tasks. For example, in response to determining that there are two-hundred shipping containers to be constructed, the FC server 102 may be configured to determine that two personnel should be assigned to that task during the next upcoming working period. In some embodiments, the FC server 102 is configured to automatically determine the number of personnel to assign to a task based on one or more of: 1) the quantity or number of the task to be completed and/or 2) performance metrics of personnel associated with the task. For example, the quantity of shipping containers may be two-hundred and for each personnel having personnel associated data stored in the database, there may be performance metric data indicating, for each personnel, how many shipping containers they construct on average within an amount of time (e.g., personnel 1 constructs one-hundred shipping containers per hour on average). The performance metric data is discussed in more detail below.

In some embodiments, the FC server 102 is configured to automatically determine which personnel are available to be assigned to pending tasks for an upcoming working period. For example, the FC server 102 may query or search the database 106 for personnel specific data including an indication that personnel are working in the upcoming working period and have not been assigned to any tasks yet. In this manner, the FC server 102 may be configured to generate roster data including an indication of personnel available to perform one or more tasks during an upcoming working period. In some embodiments, the FC server 102 is configured to determine, from the personnel included in the roster data, which personnel to assign to each task included in the pending task data. In some embodiments, the FC server is configured to determine which personnel to assign to pending tasks based on a comparison of the performance metric data for each personnel

For example, the performance metric data for personnel 1 for a task of constructing shipping containers may be higher than the performance metric data for personnel 2 for that task. The FC server 102 may be configured to compare for each pending task, the associated performance metric data for each personnel and automatically assign a number of personnel having the highest metrics to the tasks in accordance with the determined number of personnel to be assigned to the task. For example, and as discussed above, the FC server 102 determines that two personnel should be assigned to the task of constructing two-hundred shipping containers during the next upcoming working period. The FC server 102 may determine the roster data including the listing of personnel available during the next upcoming working period and, from the listing of available personnel, determine which two personnel have the highest performance metrics for the task of constructing shipping containers. In response to determining the two personnel having the highest performance metric data for constructing shipping containers that are available during the next working period, the FC server 102 may automatically assign those personnel to that task for the next upcoming working period. In this manner, the FC server 102 may be configured to automatically assign a personnel to pending tasks sufficient to complete the pending tasks.

In some embodiments, the FC server 102 is configured to receive, from an external source (e.g., external server), data relating to performance metrics of resources and automatically assign resources in accordance with the received performance metrics. The external source may be configured to receive and record, for one or more resources (e.g., personnel), performance metric data indicating the resources performance for one or more tasks. For example, for a task of assembling shipping containers, the performance metric data received and recorded by the external source may include, for a given personnel, the number of shipping containers successfully assembled within a predetermined amount of time (e.g., number of shipping containers per hour). The external source may be in communication with the FC server 102 and configured to transmit to the FC server 102 the performance metric data. For example, the FC server 102 may be configured to receive from an external source, data indicating that a first personnel has higher productivity in a first task than a second personnel and automatically assign the first personnel to the first task.

In some embodiments, the FC server 102 is configured to automatically render an assignment of personnel to tasks for a given work period based on a predetermined maximum number of work period personnel. In some embodiments, the FC server 102 is configured to receive a value for the predetermined maximum number of work periods from an external source (e.g., external server) that is configured to determine a maximum number of personnel for a given work period based on a cost analysis. The external server may be a server in communication with the FC server 102 and configured to automatically perform the cost analysis by comparing data indicating an amount of personnel in a given work period to data corresponding to an expected and/or realized production value within the given work period. The data corresponding to an expected and/or realized production may include, for example, a number of completed tasks within a given work period. In this manner, the external server may be configured to automatically determine an optimal and/or maximum number of personnel to include in a work period that maximizes the cost of the personnel with an expected production yield based on the data. The external server may be in communication with the FC server 102 and configured to transmit the determined maximum number of personnel to the FC server 102. The FC server 102 may be configured to receive the predetermined maximum number of work period personnel from the external server and automatically render an assignment a number of personnel to tasks that is less than or equal to the predetermined maximum. For example, if the maximum number is twenty personnel, the FC server 102 may automatically causes the admin UI 200 to render an assignment of up to twenty personnel to different tasks included in the rendering for a given work period. In some embodiments, the FC server 102 is configured to automatically assign resources (e.g., personnel) to tasks and update the corresponding data stored in database 106 and rendering at the UI 200 based on one or more of: 1) data relating to one or more pending tasks to be completed, 2) data relating to resource performance metrics, and/or 3) a predetermined maximum number of work period resources as described above. Referring to FIG. 3K, in some embodiments, the FC server 102 is configured to automatically generate a non-administrator UI (e.g., non-admin UI 300) based on detecting one or more user inputs at the admin UI 200. The non-admin UI 300 may include a task board display field 306 that is generally the same as the task board display field 206 displayed at the admin UI 200. For example, the task board display field 306 shown in FIG. 3K has generally the same appearance as the task board display field 206 shown in FIG. 3I. The task board display field 306 may include one or more resource icons 314 that are generally the same as the interactable icons 214 except that in some embodiments, the resource icons 314 may not be interactable via the non-admin UI 300. In some embodiments, the FC server 102 is configured to automatically update the non-admin UI 300 in response to detecting a placement of an interactable icons 214 within the task display field 206 at the admin UI 200 (as shown in FIGS. 3G-3I). For example, as the FC server 102 detects a placement of an interactable icon 214 within the task display field 206 at the admin UI 200, the FC server 102 may automatically cause the display of the non-admin UI 300 to be updated to match the detected placement.

In some embodiments, the FC server 102 is configured to automatically transmit the non-admin UI 300 to one or more display devices 108. For example, the FC server 102 may automatically transmit the generated non-admin UI 300 to one or more display devices 108 in communication with the FC server 102 such that the non-admin UI 300 is displayed thereon. In this manner, the FC server 102 may cause display devices 108 to display the non-admin UI 300 such that one or more resources, such as, but not limited to, personnel, employees and/or contractors may view their task assignments as defined by an administrator (e.g., personnel in a supervisory or managerial role). In some embodiments, there may be a plurality of display devices 108 in communication with the FC server 102 and the FC server 102 may transmit the non-admin UI 300 to one or more of the plurality of display devices 108.

In some embodiments, the FC server 102 is configured to determine that a corresponding date and/or time of day is within a working period as defined by department specific and/or task board specific data stored on the database 106 and automatically transmit a corresponding non-admin UI 300 to one or more display devices 108 for display. For example, the department (e.g., department 1) and/or task board (e.g., task board 1) selected by the administrator at the admin UI 200 in FIGS. 3D-3J may have corresponding department and/or task board specific data stored on database 106. The corresponding department and/or task board specific data may include an indication as to the dates and times that the selected task board is applicable to. For example, task board 1 may be applicable to Mondays, Tuesday, Wednesday, and Friday at a time of day corresponding to one or more working periods (e.g., during day shift, evening shift, night shift, or a combination thereof). For sake of brevity, the date(s) and/or time(s) that a task board is applicable will be referred to as an applicable time period. A task board applicable time period may generally refer to the period of time in which it would be relevant or appropriate to display the task board (e.g., as non-admin UI 300) to personnel. The FC server 102 is configured to determine that a current date and/or time matches or is within an applicable time period for a specific task board and transmit a corresponding non-admin UI 300 to the one or more display devices 108.

In some embodiments, the FC server 102 may be configured to determine whether a resource assigned to a task board included in a non-admin UI displayed at a display device is currently clocked-in to work. The resource specific data stored on database 106 may include an indication as to whether or not a corresponding resource (e.g., personnel) is currently available (e.g., clocked-in) at the workplace. Put another way, the database 106 may include an indication, for each resource having resource specific information stored thereon, of whether or not the resource is available or has arrived at the workplace. In some embodiments, the FC server 102 may be configured to cause the non-admin UI 300 to provide a visual indication that a resource assigned to a task on the displayed task board is not available. For example, the FC server 102 may determine that personnel 8 assigned to task H, as shown in FIG. 3K, is not clocked in, based on the resource specific data stored on database 106. As such, the FC server 102 may be configured to cause the corresponding resource icon 314 (e.g., employee icon “Per 8”) to be rendered on the admin and/or non-admin UI 200, 300 with a visual indication that the resource is not clocked-in. In some embodiments, the visual indication may be a color fill (e.g., a red fill, yellow fill, gray fill). It should be understood that the color fill is only an example and that any other suitable visual indication may be generated by the FC server 102.

In some embodiments, the FC server 102 is configured to receive an update of one or more resource task assignments rendered at the admin UI 200 and update a non-admin UI 300 that is being currently displayed at one or more display devices 108. For example, at a time during a working period or prior to it, the FC server 102 may detect one or more user inputs at the admin UI 200 indicating that an assignment of a resource to a task is to be changed. In some embodiments, the indication detected by the FC server 102 may include a movement and/or placement of an interactable icon 214 from a first location to a second location within the task board display field 206. For example, and referring to FIG. 3J, the FC server 102 may detect the movement and placement of the interactable icon 214 for personnel 1 “Per 1” from a first location corresponding to task A to a second location corresponding to task D. In response to detecting the movement and placement, the FC server 102 may automatically cause the non-admin UI 300 to render the same change and, in some embodiments, may cause the non-admin UI 300 to render a visual indication that a change in the assignment has occurred. For example, and continuing from the previous example, the non-admin UI may render the resource icon 314 for personnel 1, also labelled “Per 1” in FIG. 3K, to flash with a color or gradient and/or include a color fill.

In some embodiments, the FC server 102 is configured to automatically transmit different non-admin UIs 300 to one or more different display devices 108. There may be a plurality of display devices 108 in communication with the FC server 102 and each of which may have corresponding display device data stored on the database 106. The display device data stored on the database 106 may include an association with department specific data for one or more departments stored on database 106. For example, a first subset of display devices 108 may be associated with a first department and a second subset of display devices 108 may be associated with a second department. As such, the display device data and department data stored on database 106 may include an indication of the association thereof. The database 106 may also store task board specific data for a plurality of different task boards generated by an administrator (e.g., as shown in FIGS. 3A-3I). The task board specific data for the plurality of different task boards stored on database 106 may include an indication of an association with department data for one or more different departments. For example, data associated with a first task board may be associated with data for a first department and data associated with a second task board may be associated with data for a second department.

The FC server 102 may configured to automatically determine the association of task board data, display device data, and department data stored on database 106 and transmit the non-admin UIs 300 corresponding to the task board data to the corresponding displays. For example, and continuing from the example above, the FC server 102 may transmit the first task board, as a first non-admin UI 300, to the first subset of display devices 108 associated with the first department and may transmit the second task board, as a second non-admin UI 300, to the second subset of display devices 108 associated with the second department. In this manner, the FC server 102 may automatically transmit for display, one or more separate and distinct non-admin UIs 300 each displaying a different task board to display devices 108 for the appropriate department. This may be particularly beneficial in workplaces (e.g., warehouses) where multiple departments operate.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order.

What is claimed is:

1. A system for generating and displaying a graphical user interface indicating the assignment of one or more resources to one or more tasks, the system comprising:
a database having stored thereon resource specific data for a resource, task specific data for a task, task board specific data and department specific data;
a fulfillment center (FC) server in communication with the database, the FC server configured to generate an administrator facing user interface (UI) including an interactable icon corresponding to resource specific data for the resource and a first task board display field including task locations corresponding to task specific data for the one or more task, the FC server further configured to generate a non-administrator facing UI including a second task board display field;
a client device in communication with the FC server and configured to receive and display the administrator facing UI, the client device further configured to receive an input indicating a selection and movement of at least one of the interactable icons to a location within the first task board display field; and
a display device in communication with the FC server and configured to display the non-administrator facing UI including the second task board display field,
wherein the FC server is configured to:
in response to detecting the input received at the client device, automatically cause the database to create an association between resource specific data and task specific data correspond to the selected interactable icon and the location within the first task board display field; and
update the second task board display field of the non-administrator UI to include a graphical representation of the selected interactable icon at a location within the second task board display field corresponding to the location within the first task board display field.

2. The system of claim 1, wherein the location within the first task board display field corresponds to the task specific data for the task.

3. The system of claim 1, wherein the FC server is configured to automatically update the second task board display field in real time with the detected input received at the client device.

4. The system of claim 1, wherein the FC server is further configured to update the second task board display field based on an association of the display device with the department specific data.

5. The system of claim 1, wherein the FC server is configured to determine that a current date and/or time corresponds to a time period associated with the first task board display field and automatically update the second task board display field in response to the determination.

6. The system of claim 1, wherein the FC server is configured to automatically cause a plurality of the display devices to render the updated second task board display field of the non-administrator UI simultaneously.

7. A method of generating and displaying a graphical user interface indicating the assignment of one or more resources to one or more tasks, the method comprising:
at a fulfillment center (FC) server in communication with a database having stored thereon resource specific data for a resource, task specific data for a task, task board specific data and department specific data:
generating an administrator facing user interface (UI) including an interactable icon corresponding to resource specific data for the resource and a first task board display field including task locations corresponding to task specific data for the one or more task; and
generating a non-administrator facing UI including a second task board display field;
at a client device in communication with the FC server:
receiving and displaying the administrator facing UI;
receiving an input indicating a selection and movement of at least one of the interactable icons to a location within the first task board display field;
at a display device in communication with the FC server, displaying the non-administrator facing UI including the second task board display field;
at the FC server:
in response to detecting the input received at the client device, automatically causing the database to create an association between resource specific data and task specific data corresponding to the selected interactable icon and the location within the first task board display field; and
updating the second task board display field of the non-administrator UI to include a graphical representation of the selected interactable icon at a location within the second task board display field corresponding to the location within the first task board display field.

8. The method of claim 7, wherein the location within the first task board display field corresponds to the task specific data for the task.

9. The method of claim 7 further comprising:
at the FC server, automatically updating the second task board display field in real time with the detected input received at the client device.

10. The method of claim 7 further comprising:
at the FC server, updating the second task board display field based on an association of the display device with the department specific data.

11. The method of claim 7 further comprising:
at the FC server, determining that a current date and/or time corresponds to a time period associated with the first task board display field and automatically updating the second task board display field in response to the determination.

12. The method of claim 7 further comprising:
at the FC server, causing a plurality of the display devices to render the updated second task board display field of the non-administrator UI simultaneously.
